(19) United States
(12) Patent Application Publication
(10) Pub. No.: US 2004/0222076 A1
(43) Pub. Date: Nov. 11, 2004

(54) Environmentally tempered pressure switch

(76) Inventors: Thomas J. Webb, Hamden, CT (US); Sharon C. Webb, Hamden, CT (US); Lauren R. Webb, Hamden, CT (US); Jordan M. Webb, Hamden, CT (US)

Correspondence Address: THOMAS J. WEBB, 1021 RIDGE ROAD, HAMDEN, CT, 06517, US

(21) Appl. No.: 10/445,364

(22) Filed: May 9, 2003

(51) Int. Cl. H01H 29/16

(52) U.S. Cl. 200/512

(57) ABSTRACT

A pressure actuated switch assembly has a hermetically sealed electrical switch exceeding MIL-PRF-8805 requirements. A sensing element is positioned within the pressure switch housing for triggering the electrical switch at a precise pressure point(s). An electrical signal connection is positioned on the pressure switch housing. A pressure interface is also positioned on the pressure switch housing. The pressure switch housing is made of a nickel or titanium alloy for environmental protection.

### BACKGROUND OF THE INVENTION

This application was filed on May 5, 2003.

### TECHNICAL FIELD

This invention relates to a hermetically sealed pressure switch assembly and more particularly to such a sealed pressure switch assembly useful in an aircraft for regulating pressure relative to aircraft system requirements.

### BACKGROUND INFORMATION

A sealed pressure switch assembly is useable when differential pressure is translated into an electrical signal. Such assemblies are used in aircraft to effectively regulate pressure relative to aircraft system requirements. Differential or gage pressure between a reference pressure and the system to be measured is converted from mechanical motion into an electrical signal. The pressure settings to obtain an electrical indication can be varied significantly, and correspond to the specific design requirements of the sensing mechanism. The pressure switch and electrical switch are also designed for various types of signals that are interpreted by other systems supplied by the aircraft or other sources.

The pressure switches are used on, but not limited to, the following systems: pneumatic, hydraulic, fuel, and oil. Primary use of this invention is in aerospace systems, but it can be used in many other environmentally demanding applications. Pressure switches used currently in industry are limited in reliability and accuracy at temperatures of 450 degrees F. continuous use and above. Exposure to vibration and a variety of chemicals in the operating environment further limits performance.

Typically, aircraft applications are extremely demanding in that there can be significant levels of vibration and temperature present along with damaging chemicals ranging from fuels and oils to chemical cleaners. Design limitations with other pressure switch assemblies result in operational reliability deficiencies. The primary problem is loss of accuracy and precision with time and service, resulting in spurious pressure switch signals that cause monitoring system maintenance messages, and incorrect system operation.

Pressure indication from previously designed assemblies has caused numerous technical problems. The primary area of concern is that the electrical switch assembly resistance changes. This causes diminished system accuracy on the aircraft or other application. This results in the aircraft using pressure function information without the required precision and accuracy. Changes in the pressure switch assemblies and consequently system precision are not necessarily consistent with time, but vary from unit to unit based on unit construction, time since built, electrical system contamination, and run time on engines, among other variables. Thus, a need exists for an environmentally tempered pressure switch.

### SUMMARY OF THE INVENTION

Briefly, the present invention satisfies the need for an environmentally tempered pressure switch that will accurately reproduce the original reference pressure settings, for extended periods of time. The present invention provides a hermetically sealed electrical switch assembly. A nickel or titanium alloy housing is also provided for the switch assembly to prevent attack by environmental elements. The sensing element is designed to trigger the switch at a precise pressure point or points. The electrical signal is transmitted from the pressure switch by an electrical connector or lead wire assembly. The interface dimensions, such as pressure ports and electrical connections, are determined primarily by system design. These and other features of this invention will become apparent from the following detailed description of the various aspects of the invention taken in conjunction with the accompanying drawing.

### BRIEF DESCRIPTION OF THE DRAWING

FIG. 1 is a partial cross-sectional view of an environmental tempered pressure switch made in accordance with the present invention.

### BEST MODE FOR CARRYING OUT THE INVENTION

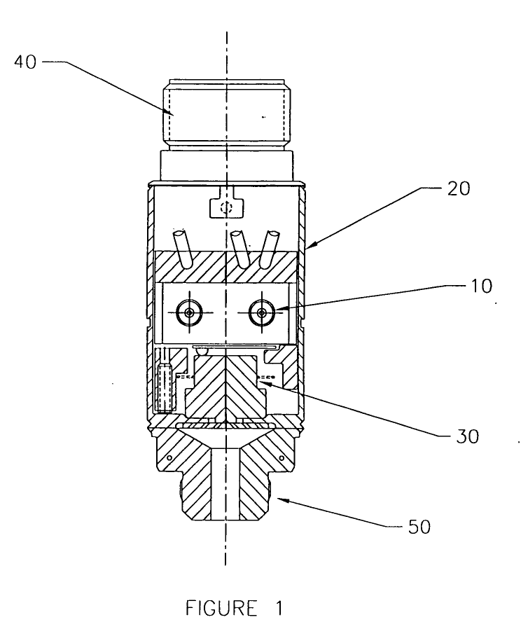

FIG. 1 is a partial cross-sectional view of an environmentally tempered pressure switch, made in accordance with the present invention. Electrical switch 10 is a hermetically sealed assembly. It exceeds the military specification MIL-PRF-8805 requirements for a hermetically sealed electrical switch assembly. Copies of military specifications are available, for example, at the Defense Automated Printing Service Building 4/D, 700 Robbins Avenue, Philadelphia, Pa. 19111-5094.

The pressure switch in FIG. 1 has a housing 20 of a nickel or titanium alloy, selected from a wide variety of such alloys to prevent attack by environmental elements in operation use. Within casing 20 is positioned sensing element 30 for triggering switch 10 at a precise point or points. The electrical signal is transmitted via connector or lead wire assembly 40 from the pressure switch in FIG. 1. Interface 50 (FIG. 1) is typical of pressure ports used. Electrical connections and pressure fittings are primarily determined by the sensing system design.

To alleviate the inconsistencies of current available pressure switch assemblies, a more rugged pressure switch electrical switch assembly was developed and tested to higher temperature ratings: 900 degree F. continuous, 1000 degree F. intermittent ratings. High vibration, harsh chemical and rugged environmental requirements were also provided for. Extensive laboratory testing produced an extremely capable pressure switch assembly that will reproduce the original reference pressure settings for extended periods of time. Unlike existing designs, this design eliminates electrical system contamination by exceeding MIL-PRF-8805 Hermetic Sealed Switch requirements—thus eliminating contamination of the electrical pathway as a failure source. Specifically, helium leak rates are below 9×10⁻⁹ cubic centimeters per second; significantly lower than required by MIL-PRF-8805. The pressure switch assembly also meets MIL-STD-810 and RTCA-DO-160 Environmental Testing Procedures for Turbine/Turbojet Engine Requirements. These standards include vibration and environmental conditions.

Scientific analysis of the most severe environmental conditions for the foreseeable future and specifications from the present requirements of the intended installation enable the design of the pressure switch assembly to withstand the rugged environment on modem aircraft and engines. The causes of reference pressure switch changes and spurious indication sources have been eliminated using a more robust pressure switch design.

While specific embodiments of the present invention have been described it will be apparent to those skilled in the art that various modifications thereto can be made without departing from the spirit and scope of the invention as defined in the appended claims.

What I claim is:

1. A pressure sensing assembly partially comprised of a hermetically sealed electrical switch assembly that exceeds MIL-PRF-8805 requirements. Said electrical switch has confirmed helium leak rates below 9×10⁻⁹ cubic centimeters per second, and is actuated at a precise pressure point(s), and positioned within said pressure switch housing. Electrical signal is transmitted by lead wire assembly through said housing.

2. The pressure switch assembly and electrical switch of claim 1 wherein said housing is a nickel or titanium alloy.
